(19) United States
(12) Patent Application Publication
(10) Pub. No.: US 2008/0014104 A1
(43) Pub. Date: Jan. 17, 2008

(54) Fan, motor and bearing structure

(75) Inventors: Chien-Hsiung Huang, Taoyuan Hsein (TW); Lee-Long Chen, Taoyuan Hsien (TW); Shih-Ming Huang, Taoyuan Hsien (TW)

Correspondence Address: BIRCH STEWART KOLASCH & BIRCH, PO BOX 747, FALLS CHURCH, VA, 22040-0747, US

(73) Assignee: DELTA ELECTRONICS INC.

(21) Appl. No.: 11/819,616

(22) Filed: Jun. 28, 2007

(30) Foreign Application Priority Data
Jul. 17, 2006 (TW) 095126098

(51) Int. Cl. F04B 17/03; F16C 27/06; H02N 11/00

(52) U.S. Cl. 417/423.7; 310/300; 384/215

(57) ABSTRACT

A bearing structure has a bearing and a shockproof structure. The bearing is disposed in a bushing. The shockproof structure is disposed in the bushing for covering at least one portion of the outer wall of the bearing.

### CROSS REFERENCE TO RELATED APPLICATIONS

This Non-provisional application claims priority under 35 U.S.C. §119(a) on Patent Application No(s). 095126098 filed in Taiwan, Republic of China on Jul. 17, 2006, the entire contents of which are hereby incorporated by reference.

### BACKGROUND OF THE INVENTION

1. Field of Invention

The invention relates to a fan, a motor, and a bearing structure, and in particular, to a fan, a motor and a bearing structure with a shockproof function.

2. Related Art

Bearing structures are widely used in electronic devices. With the bearing structure used in a motor as an example, they are mainly ball bearings or sleeve bearings. Since sleeve bearings are advantageously characterized by easier manufacture, lower cost, and higher yield than ball bearings, they are used extensively in the industry.

As shown in FIG. 1, a conventional bearing 13 used in the motor is a sleeve bearing disposed in a bushing 141 of a base 14, forming a space 15 at its bottom. Lubricant oil is filled in the space 15. A shaft 111 of the rotor 11 in the motor is pivotally disposed in an axial hole 131 of the bearing 13. Since the usual bearing 13 is formed by sintering a powder metallurgical material, the material is softer than that of the solid shaft 111. The lubricant oil is brought upward under the high-speed rotation of the shaft 111, reducing the friction between the shaft 111 and the bearing 13 and buffering the radial vibration of the shaft 111. However, the ascending lubricant oil continuously leaks out of the gap 12 between the shaft 111 and the bearing 13 as the shaft 111 rotates at a high speed, or evaporates due to the heat produced by friction.

The loss of lubricant oil due to the above-mentioned causes will result in contact friction between a running shaft 111 and the wall of the axial hole 131, as shown in the parts (a) and (b) of FIG. 2. The friction at the upper and lower ends of the axial hole 131 is particularly serious, giving rise to hole enlarging. Moreover, as the friction between the shaft 111 and the bearing 13 increases, the abrupt rise in temperature can readily produce carbonates and noise. Thus, the lifetime of the bearing 13 is reduced.

Therefore, it is an important subject to provide a fan, a motor, and a bearing structure using a sleeve bearing with a shockproof structure for extending the lifetime thereof.

### SUMMARY OF THE INVENTION

In view of the foregoing, the invention is to provide a fan, a motor and a bearing structure using a bearing with a shockproof structure for extending the lifetime thereof.

To achieve the above, the invention discloses a shockproof structure of a bearing, which is disposed in a bushing. The shockproof structure is disposed in the bushing to cover at least one portion of the outer wall of the bearing.

To achieve the above, the invention also discloses a bearing structure in combination with a shaft and disposed in a bushing. The bearing structure includes a bearing and a shockproof structure. The bearing has an axial hole for inserting the shaft therethrough. The shockproof structure is disposed in the bushing for covering at least one portion of the outer wall of the bearing. The shockproof structure is a hollow cylinder, a hollow pillar, or a wavy cylinder.

To achieve the above, the invention discloses a motor including a rotor, a stator and a bearing structure. The rotor has a shaft. The stator is mounted on a bushing and is coupled to the rotor. The bearing structure includes a bearing and a shockproof structure. The bearing has an axial hole for inserting the shaft therethrough. The shockproof structure is disposed in the bushing for covering at least one portion of the outer wall of the bearing.

To achieve the above, the invention discloses a fan including an impeller, a rotor, a stator and a bearing structure. The impeller includes a hub and a plurality of blades disposed around the hub. The rotor has a shaft connected to the hub. The stator is mounted on a bushing and is coupled to the rotor. The bearing structure includes a bearing and a shockproof structure. The bearing has an axial hole for inserting the shaft therethrough. The shockproof structure is disposed in the bushing for covering at least one portion of the outer wall of the bearing.

As mentioned above, the fan, motor, and bearing structure of the invention use a shockproof structure to cover at least one portion of the outer wall of a bearing. The shockproof structure is made of an elastic material. When the shaft of the bearing is rotating at a high speed, the shockproof structure and the wall of the axial hole maintain only superficial contact under the radial vibrations due to imbalance. The use of the shockproof structure provides a radial buffering force for the shaft. Compared with the prior art, the invention has a shockproof structure to provide buffering forces to vibrations in the bearing structure. Therefore, the shaft maintains only surface contact with the bearing under the unbalanced operation. The problems of forming a large hole and noise due to friction as in the prior art can be avoided. Therefore, the lifetime of the bearing can be extended.

### BRIEF DESCRIPTION OF THE DRAWINGS

The invention will become more fully understood from the detailed description given herein below illustration only, and thus is not limitative of the present invention, and wherein:

FIG. 1 schematically shows a conventional bearing;

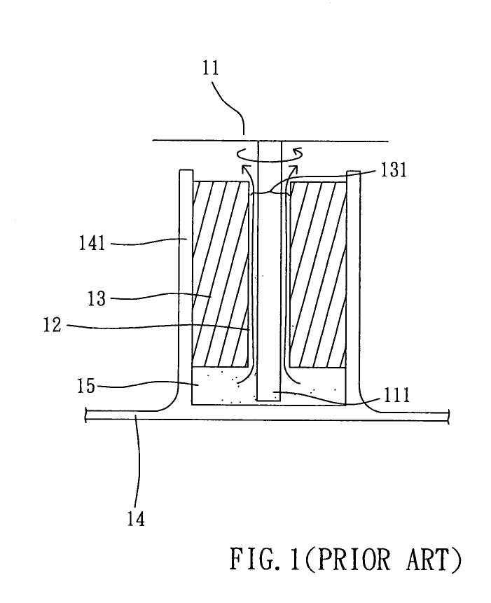

FIG. 2 is a schematic view showing that a contact friction exists between the conventional bearing and a shaft;

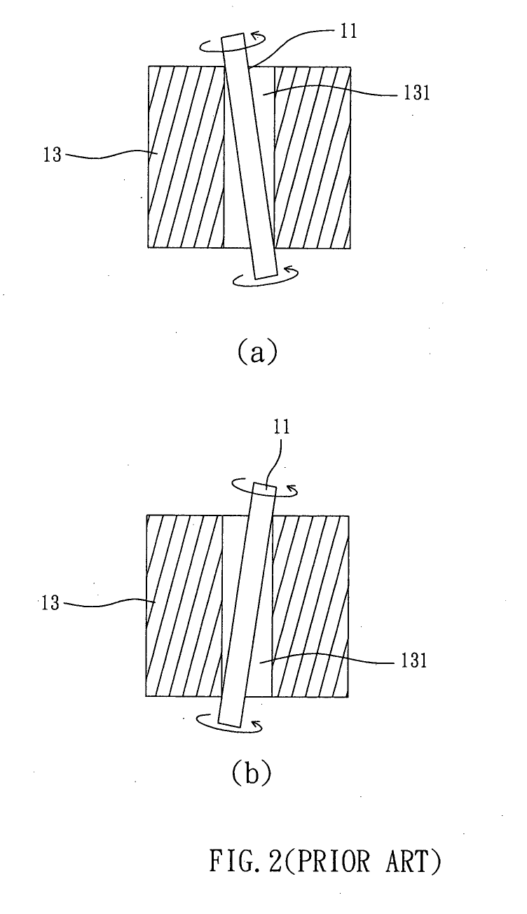

FIG. 3 is a schematic view of a fan according to an embodiment of the invention;

FIG. 4 is a partial enlarged view of the fan according to the embodiment of the invention; and

FIG. 5 is a schematic view of a motor according to an embodiment of the invention.

### DETAILED DESCRIPTION OF THE INVENTION

The present invention will be apparent from the following detailed description, which proceeds with reference to the accompanying drawings, wherein the same references relate to the same elements.

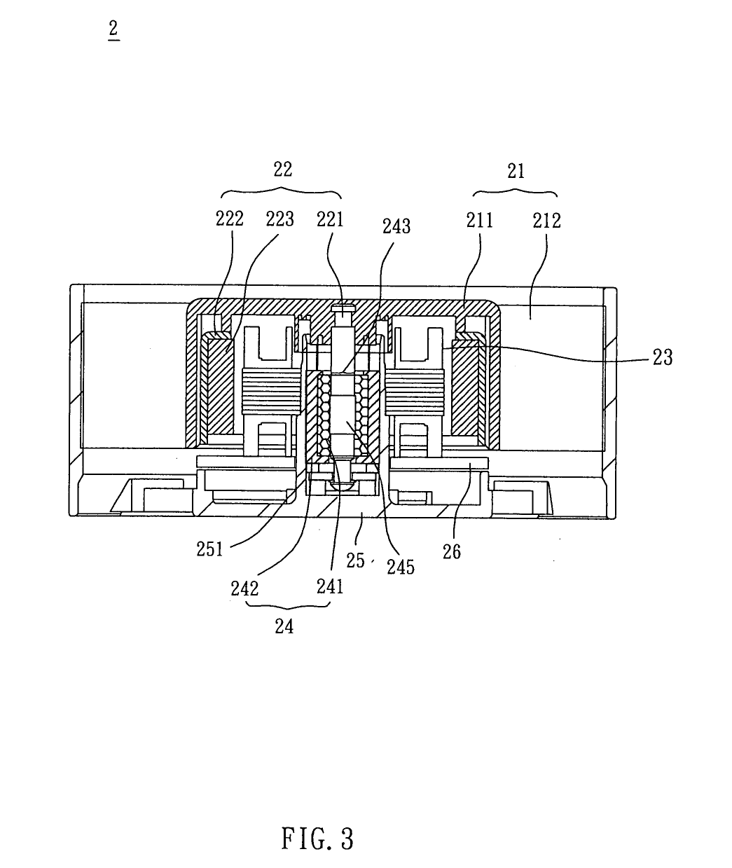

As shown in FIG. 3, a fan 2 according to an embodiment of the invention includes an impeller 21, a rotor 22, a stator 23, and a bearing structure 24.

The impeller 21 has a hub 211 and several blades 212 disposed around of the hub 211. The blades 212 can be formed with the hub 211 as a monolithic piece.

The rotor 22 has a shaft 221 connected with the hub 211. The shaft 221 can be integrally formed with the hub 211. Moreover, the rotor 22 has a magnetic conducting shell 222 and a magnet 223. The magnetic conducting shell 222 is made of a metal material and disposed around the inner wall of the hub 211. The magnet 223 is a permanent magnet disposed around the inner wall of the magnetic conducting shell 222.

The stator 23 is mounted on a bushing 251 of a base 25. A circuit board 26 is disposed at the outer edge of the bushing 251 and on the base 25. The stator 23 is electrically connected with the circuit board 26 and coupled to the rotor 22, particularly corresponding to the magnet 223 of the rotor 22. The circuit board 26 controls the direction of electrical current in the armature on the stator 23. The electrical current produces an alternating magnetic field with the magnet 223 of the rotor 22 to drive the rotor 22.

The bearing structure 24 includes a bearing 241 and a shockproof structure 242. The bearing 241 has an axial hole 243 for inserting the shaft 221 therethrough. The shockproof structure 242 is disposed in the bushing 251 to cover at least one portion of the outer wall of the bearing 241. That is, the shockproof structure 242 can partially or completely cover the outer wall of the bearing 241. The bearing 241 is made by sintering a powder metallurgical material. In this embodiment, the bearing 241 is a sleeve bearing or a dynamic pressure bearing.

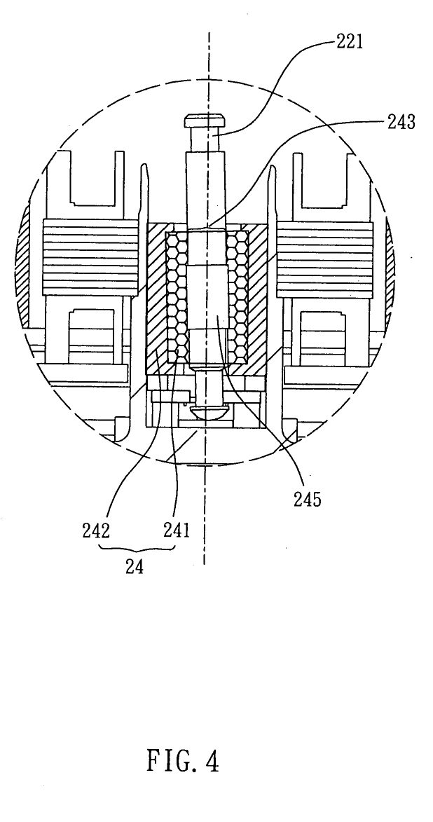

In this embodiment, the shockproof structure 242 is made of an elastic material, such as rubber or sponge, and disposed between the outer wall of the bearing 241 and the inner wall of the bushing 251. The shockproof structure can be a hollow cylinder, a hollow pillar, or a wavy cylinder. As shown in FIG. 4, when the shaft 221 deviates and imposes a pressure on the bearing structure 24, the unbalanced force of the shaft 221 in the radial direction is buffered by the shockproof structure 242. The elastic material makes the bearing structure 24 elastic. Therefore, the contact between the deviated shaft 221 and the bearing structure 24 is superficial. This can effectively reduce the enlarging of the axial hole 243 or noises between the shaft 221 and the bearing 241 due to point contacts or collisions.

Furthermore, as shown in FIGS. 3 and 4, the inside of the bearing 241 in this embodiment can be provided with an oil reservoir 245. The oil reservoir 245 contains lubricant oil for increasing the oil content of the bearing 241. Moreover, the oil reservoir 245 refills the lubricant oil loss from the fan 2.

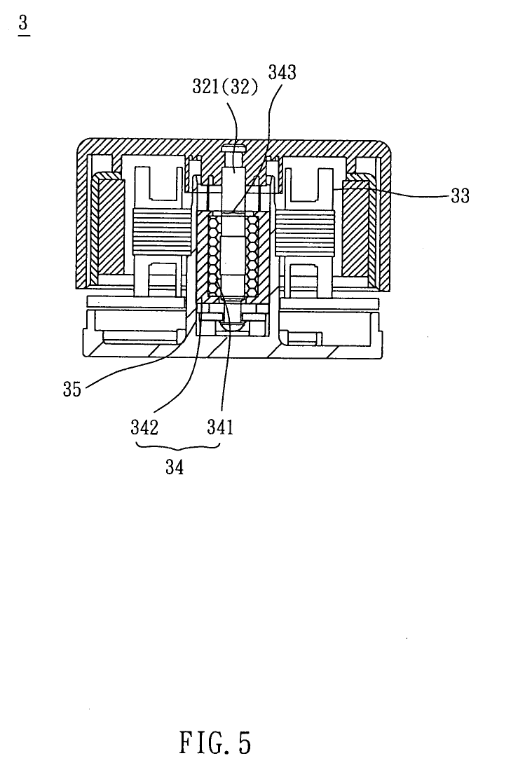

As shown in FIG. 5, a fan 3 according to an embodiment of the invention includes a rotor 32, a stator 33, and a bearing structure 34. The rotor 32 has a shaft 321. The stator 33 is mounted on a bushing 35, corresponding to the rotor 32, for driving the rotor 32.

The bearing structure 34 includes a bearing 341 and a shockproof structure 342. The bearing 341 has an axial hole 343 for inserting the shaft 321 therethrough. The shockproof structure 342 is disposed in the bushing 35 to cover at least one portion of the outer wall of the bearing 341. The bearing 341 can be a sleeve bearing or a dynamic pressure bearing.

In this embodiment, the relative positions, composition materials, structural features and functions of the rotor 32, the stator 33, the bearing structure 34 and the bushing 35 are the same as those of the elements in the previous embodiment. Therefore, the description is not repeated herein again.

In summary, the fan, motor, and bearing structure of the invention use a shockproof structure to cover at least one portion of the outer wall of a bearing. The shockproof structure is made of an elastic material. When the shaft of the bearing is rotating at a high speed, the radial vibrations occur due to imbalance. The use of the shockproof structure provides a radial buffering force for the shaft. Compared with the prior art, the invention has a shockproof structure to provide buffering forces to vibrations in the bearing structure. Therefore, the shaft maintains only surface contact with the bearing under the unbalanced operation. The problems of forming a large hole and noise due to friction as in the prior art can be avoided. Therefore, the lifetime of the bearing can be extended.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A bearing structure in combination with a shaft and disposed in a bushing, the bearing structure comprising:
a bearing having an axial hole for inserting the shaft therethrough; and
a shockproof structure disposed in the bushing for receiving the bearing.

2. The bearing structure of claim 1, wherein the shockproof structure is made of an elastic material, rubber or sponge.

3. The bearing structure of claim 1, wherein the shockproof structure completely or partially covers an outer wall of the bearing.

4. The bearing structure of claim 1, wherein the shockproof structure is a hollow cylinder, a hollow pillar, or a wavy cylinder.

5. The bearing structure of claim 1, further comprising an oil reservoir is disposed inside the bearing for holding a lubricant oil.

6. The bearing structure of claim 1, wherein the bearing is made by sintering a powder metallurgical material.

7. A motor comprising:
a rotor having a shaft;
a stator mounted on a bushing and coupled to the rotor; and
a bearing structure including a bearing having an -axial hole and a shockproof structure, wherein the shaft is inserted into the axial hole, and the shockproof structure is disposed in the bushing for receiving the bearing.

8. The motor of claim 7, wherein the shockproof structure is made of an elastic material, rubber or sponge.

9. The motor of claim 7, wherein the shockproof structure completely or partially covers an outer wall of the bearing.

10. The motor of claim 7, wherein the shockproof structure is a hollow cylinder, a hollow pillar, or a wavy cylinder.

11. The motor of claim 7, wherein the bearing is a sleeve bearing or a dynamic pressure bearing.

12. The motor of claim 7, further comprising an oil reservoir is disposed inside the bearing for a holding lubricant oil.

13. The motor of claim 7, wherein the bearing is made by sintering a powder metallurgical material.

14. A fan comprising:
an impeller including a hub and a plurality of blades disposed around the hub;
a rotor having a shaft connected to the hub;
a stator mounted on the bushing and coupled to the rotor; and
a bearing structure including a bearing having a bearing having an axial hole and a shockproof structure, wherein the shaft is inserted into the axial hole, and the shockproof structure is disposed in the bushing for receiving the bearing.

15. The fan of claim 14, wherein the shockproof structure is made of an elastic material, rubber or sponge.

16. The fan of claim 14, wherein the shockproof structure completely or partially covers an outer wall of the bearing.

17. The fan of claim 14, wherein the shockproof structure is a hollow cylinder, a hollow pillar, or a wavy cylinder.

18. The fan of claim 14, wherein the bearing is a sleeve bearing or a dynamic pressure bearing.

19. The fan of claim 14, further comprising an oil reservoir is disposed inside the bearing for holding a lubricant oil.

20. The fan of claim 14, wherein the bearing is made by sintering a powder metallurgical material.
